(19) United States
(12) Patent Application Publication
(10) Pub. No.: US 2026/0142228 A1
(43) Pub. Date: May 21, 2026

(54) ORGANIC SOLID ELECTROLYTE AND ALL-SOLID-STATE SODIUM-ION BATTERY

(71) Applicant: TOYOTA JIDOSHA KABUSHIKI KAISHA, Toyoa-shi (JP)

(72) Inventor: Shinya SHIOTANI, Nagoya-shi (JP)

(21) Appl. No.: 19/297,376

(22) Filed: Aug. 12, 2025

(30) Foreign Application Priority Data
Nov. 19, 2024 (JP) 2024-201594

(51) Int. Cl. H01M 10/0562; H01M 10/054

(52) U.S. Cl. CPC H01M 10/0562; H01M 10/054; H01M 2300/0071; H01M 2300/0082; H01M 2300/0094

(57) ABSTRACT

An organic solid electrolyte includes sodium bis(fluorosulfonyl)amide (NaFSA), and polyethylene oxide (PEO), and when a constituent unit of PEO is EO, a molar ratio of Na:EO between NaFSA and PEO is within a range of 1:20 to 1:50. An all-solid-state sodium-ion battery includes a cathode layer, an organic solid electrolyte layer that is made of the above organic solid electrolyte, an inorganic solid electrolyte layer, and an anode layer, in this order in a thickness direction.

### CROSS-REFERENCE TO RELATED APPLICATION

This application claims priority to Japanese Patent Application No. 2024-201594 filed on Nov. 19, 2024. The disclosure of the above-identified application, including the specification, drawings, and claims, is incorporated by reference herein in its entirety.

### BACKGROUND

### 1. Technical Field

The present disclosure relates to an organic solid electrolyte and an all-solid-state sodium-ion battery.

### 2. Description of Related Art

Japanese Unexamined Patent Application Publication No. 2022-58019 (JP 2022-58019 A) discloses an all-solid-state sodium storage battery that is configured such that an organic solid electrolyte is interposed between an electrode composite material and an inorganic solid electrolyte.

### SUMMARY

In the all-solid-state sodium storage battery that is disclosed in JP 2022-58019 A, an activation barrier between the organic solid electrolyte and active material in the electrode composite material is high, and rate characteristics thereof are considered to be poor.

A problem to be solved by an embodiment of the present disclosure is to provide an organic solid electrolyte that is capable of improving rate characteristics of an all-solid-state sodium-ion battery, and an all-solid-state sodium-ion battery with improved rate characteristics.

Means for solving the above problem includes the following aspects.
<1> An organic solid electrolyte, including sodium bis(fluorosulfonyl)amide (NaFSA), and polyethylene oxide (PEO), in which, when a constituent unit of PEO is EO, a molar ratio of Na:EO between NaFSA and PEO is within a range of 1:20 to 1:50.
<2> The organic solid electrolyte according to <1>, further including a boron-containing additive.
<3> The organic solid electrolyte according to <2>, in which the boron-containing additive is one type, or two or more types of additives, selected from a group consisting of triphenylboroxine, triphenylborane, and fluorobis(2,4,6-trimethylphenyl)borane.
<4> The organic solid electrolyte according to <2>, in which the boron-containing additive is triphenylboroxine.
<5> An all-solid-state sodium-ion battery, including a cathode layer, an organic solid electrolyte layer, an inorganic solid electrolyte layer, and an anode layer, in this order in a thickness direction, in which the organic solid electrolyte layer is made of the organic solid electrolyte according to any one of <1> to <4>.
<6> The all-solid-state sodium-ion battery according to <5>, in which the inorganic solid electrolyte layer contains Na-β″-alumina.

According to the present disclosure, there are provided an organic solid electrolyte that is capable of improving rate characteristics of an all-solid-state sodium ion battery, and an all-solid-state sodium-ion battery with improved rate characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a layer configuration of an all-solid-state sodium-ion battery according to the present disclosure.

### DETAILED DESCRIPTION OF EMBODIMENTS

Hereinafter, an all-solid-state sodium-ion battery according to the present disclosure will be described with reference to the accompanying drawings. In the following description, signs may be omitted.

In the present disclosure, numerical value ranges that are indicated using “to” mean ranges that include numerical values written before and after the “to” as the minimum value and the maximum value, respectively. In the present disclosure, in which numerical value ranges are described in stages, an upper limit value or a lower limit value described in a certain numerical value range may be replaced with an upper limit value or a lower limit value of another numerical value range described in stages. In the numerical value ranges described in the present disclosure, an upper limit value or a lower limit value described in a certain numerical value range may be replaced with a value shown in the Examples. In the present disclosure, a combination of two or more preferred forms is a more preferred form. In the present disclosure, when there is a plurality of types of substances corresponding to each component, the amount of each component means the total amount of the substances of the multiple types, unless otherwise specified.

### All-Solid-State Sodium-Ion Battery

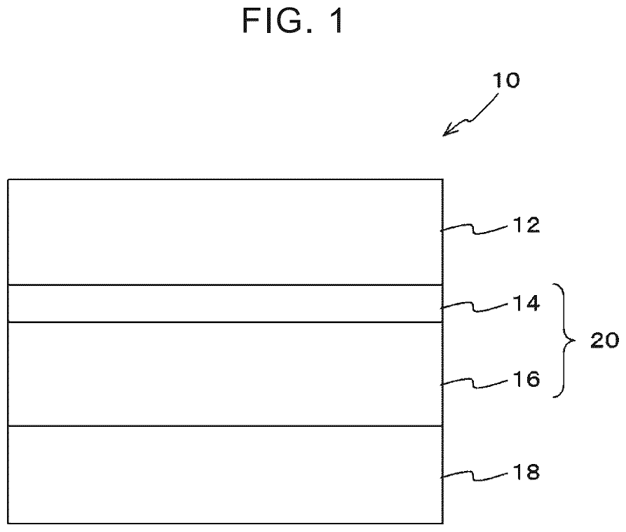

The all-solid-state sodium-ion battery according to the present disclosure includes a cathode layer, an organic solid electrolyte layer (may be referred to as “polymer SE” in the present disclosure), an inorganic solid electrolyte layer, and an anode layer, in this order in the thickness direction. FIG. 1 illustrates a schematic diagram of an example of a layer structure of an all-solid-state sodium-ion battery according to the present disclosure. An organic solid electrolyte layer 14 and an inorganic solid electrolyte layer 16 can be collectively considered to be a solid electrolyte layer 20. An all-solid-state sodium-ion battery 10 illustrated in FIG. 1 includes a cathode layer 12, the solid electrolyte layer 20, and an anode layer 18, which are laminated in this order. The solid electrolyte layer 20 includes the inorganic solid electrolyte layer 16, and the organic solid electrolyte layer 14 that is disposed between the inorganic solid electrolyte layer 16 and the cathode layer 12.

The organic solid electrolyte layer includes sodium bis(fluorosulfonyl)amide (sometimes referred to as “NaFSA” in the present disclosure) and polyethylene oxide (sometimes referred to as “PEO” in the present disclosure). In the organic solid electrolyte layer, when a constituent unit of PEO is EO, the molar ratio of Na:EO between NaFSA and PEO is within a range of 1:20 to 1:50 (sometimes written as “Na/EO=1/20 to 1/50” in the present disclosure).

Note that the solid electrolyte layer may contain an electrolytic solution in an amount of less than 10% by mass as to the total amount of the electrolyte.

In an all-solid-state sodium-ion battery including a cathode layer, an organic solid electrolyte layer, an inorganic solid electrolyte layer, and an anode layer in this order in the thickness direction, the rate characteristics are improved by using an organic solid electrolyte in which the molar ratio of Na:EO between NaFSA and PEO is within the range of 1:20 to 1:50 as the organic solid electrolyte layer. This effect is believed to be due to, but not limited to, the following reasons.

It is believed that when the molar ratio (Na/EO) of NaFSA and PEO making up the organic solid electrolyte is within the range of 1/20 to 1/50, behavior of FSA, which is an anion in the polymer SE, is suppressed by PEO, and an activation barrier for insertion and desorption of Na ions into and from the cathode active material decreases. It is believed that the rate characteristics are improved as a result.

The configuration of each layer in the all-solid-state sodium-ion battery according to the present disclosure will be described below. Note that the all-solid-state sodium-ion battery according to the present disclosure may employ the configuration of a known all-solid-state sodium-ion battery, except for the organic solid electrolyte layer.

### Cathode Layer

The cathode layer 12 can be composed of a cathode current collector and a cathode active material layer (cathode composite material) that is laminated on the solid electrolyte layer side of the cathode current collector.

Examples of the cathode current collector include stainless steel, aluminum, copper, nickel, iron, titanium, carbon, or the like, and is preferably an aluminum alloy foil or an aluminum foil. The aluminum alloy foil and the aluminum foil may be manufactured using powder. The form of the cathode current collector is, for example, a foil or a mesh.

The cathode composite material preferably contains a transition metal oxide polyphosphate. The transition metal oxide polyphosphate functions as a cathode active material.

Specifically, examples include Na₂FeP₂O₇, Na₃Fe₂(PO₄)₃, NaFe₃P₃O₁₂, Na₂Fe₃(PO₄)₃, Na₄Fe₃(PO₄)₂(P₂O₇), Na₂MnP₂O₇, Na₂CoP₂O₇, Na₂NiP₂O₇, Na₂Fe_{0.5}Mn_{0.5}P₂O₇, Na₃V₂(PO₄)₃, NaVOPO₄, Na₉V₃(P₂O₇)₃(PO₄)₂, and the like. These may be used as one type alone or in combination of two or more types.

The cathode composite material may contain transition metal oxide polyphosphate and other cathode active materials. Other cathode active materials that can be used include known materials including transition metal oxide-based materials, sulfur-based materials, solid solution-based materials, and the like.

The cathode composite material can include a resin-based binder. Examples of resin-based binders include materials such as polyvinylidene fluoride (PVDF), polytetrafluoroethylene (PTFE), polyimide (PI), polyamide, polyamideimide, polyacrylic, styrene butadiene rubber (SBR), ethylene-vinyl acetate copolymer (EVA), polypropylene carbonate (PPC), styrene-ethylene-butylene-styrene copolymer (SEBS), carboxymethyl cellulose (CMC), xanthan gum, polyvinyl alcohol (PVA), polyvinyl butyral (PVB), ethylene vinyl alcohol, polyethylene (PE), polypropylene (PP), polyacrylic acid, lithium polyacrylate, sodium polyacrylate, potassium polyacrylate, ammonium polyacrylate, methyl polyacrylate, ethyl polyacrylate, amine polyacrylate, polyacrylic acid ester, epoxy resin, polyethylene terephthalate (PET), polybutylene terephthalate (PBT), nylon, vinyl chloride, silicone rubber, nitrile rubber, cyanoacrylate, urea resin, melamine resin, phenolic resin, latex, polyurethane, silylated urethane, nitrocellulose, dextrin, polyvinylpyrrolidone, vinyl acetate, polystyrene, chloropropylene, resorcinol resin, polyaromatic, modified silicone, methacrylic resin, polybutene, butyl rubber, 2-propenoic acid, cyanoacrylic acid, methyl methacrylate, glycidyl methacrylate, acrylic oligomer, 2-hydroxyethyl acrylate, polyacetal, alginic acid, starch, sucrose, lacquer, glue, casein, and so forth.

The cathode composite material may contain a conductive aid. Examples of the conductive aid include carbon materials, metal materials, and conductive polymer materials. Examples of carbon materials include carbon black (e.g., acetylene black, furnace black, Ketjen black, and so forth), fibrous carbon (e.g., vapor grown carbon fiber, carbon nanotubes, carbon nanofibers, and so forth), graphite, carbon fluoride, and so forth.

Examples of metal materials include metal powder (e.g., aluminum powder and so forth), conductive whiskers (e.g., zinc oxide, potassium titanate, and so forth), conductive metal oxides (e.g., titanium oxide), and the like.

Examples of the conductive polymer material include polyaniline, polypyrrole, polythiophene, and so forth.

The conductive aid may be used as one type alone or as a mixture of two or more types.

The cathode layer may contain other components. Examples of other components include thickeners, surfactants, dispersants, wetting agents, antifoaming agents, and so forth.

The cathode layer can be formed by, for example, dispersing a cathode active material, a conductive agent, a resin binder, and the like, in a solvent at a predetermined ratio to prepare a slurry, and then coating a current collector with the slurry.

The thickness of the cathode layer is, for example, within a range of 0.1 μm to 500 μm from the perspectives of ion conductivity, energy density of the battery, and so forth.

### Organic Solid Electrolyte Layer

The organic solid electrolyte layer 14 is configured containing NaFSA and PEO, and the molar ratio of Na:EO between NaFSA and PEO is within the range of 1:20 to 1:50.

NaFSA is a sodium salt with sodium ion as the cation and FSA (bisfluorosulfonylamide; (FSO₂)₂N⁻) as the anion.

PEO functions as a solid electrolyte and also functions as an adhesive that bonds the cathode (electrode composite material) and the inorganic solid electrolyte layer to each other. Furthermore, PEO also has a function of suppressing the behavior of anions (FSA).

PEO is a polyether that is formed by polymerizing ethylene glycol, and may be a derivative thereof. PEO may include sulfur compound functional groups, nitrogen compound functional groups, phosphorus compound functional groups, acrylate functional groups, or the like.

In the present disclosure, the molar ratio of PEO to NaFSA is based on the number of moles of the structural unit (CH₂CH₂O) of PEO, and is independent of the weight-average molecular weight (Mw) of PEO. For example, when the molar ratio of Na:EO between NaFSA and PEO contained in the organic solid electrolyte layer is 1:20, this means that one NaFSA is present for every 20 structural units of PEO.

The weight-average molecular weight (Mw) of PEO is preferably 100,000 or more, and more preferably 250,000 or more, from the perspective of serving as an adhesive for bonding the cathode layer and the inorganic solid electrolyte layer. On the other hand, when the weight-average molecular weight of PEO is too high, the viscosity becomes too high, and there is a possibility that ionic conductivity may become low when NaFSA is mixed in. The weight-average molecular weight (Mw) of PEO is preferably 10,000,000 or less.

The weight-average molecular weight (Mw) of PEO can be found, for example, using liquid chromatography, and measurement by gel permeation chromatography (GPC).

Further, the molar ratio of Na/EO between NaFSA and PEO is preferably 1/25 to 1/50, and more preferably 1/25 to 1/40, from the perspective of improving the rate characteristics of the all-solid-state sodium-ion battery.

The organic solid electrolyte layer may include an additive containing boron. The boron-containing additive acts as an anion acceptor to suppress the behavior of anions, and the activation barrier for the insertion and desorption of Na ions into and from the cathode active material is further reduced. Examples of additives containing boron include triphenylboroxine (TPB), triphenylborane (BPh3), and fluorobis(2,4,6-trimethylphenyl)borane (FBTMPhB), and among these, TPB is preferable.

The boron-containing additive in the organic solid electrolyte layer has a molar ratio of NaFSA:additive in the range of, for example, 10:1 to 10:10.

The organic solid electrolyte layer can be formed by dissolving NaFSA and PEO in a molar ratio Na/EO range of 1/20 to 1/50, along with additives as necessary, in an organic solvent such as acetonitrile or the like, and then applying the solution to a substrate such as a fluororesin or the like and performing drying thereof.

The thickness of the organic solid electrolyte layer is, for example, within the range of 0.1 μm to 500 μm from the perspectives of ion conductivity, energy density of the battery, and the like.

### Inorganic Solid Electrolyte Layer

The inorganic solid electrolyte layer 16 is formed of an inorganic solid electrolyte. Inorganic solid electrolytes include electrolytes that are sulfide-based, oxide-based, hydride-based, and so forth. The inorganic solid electrolyte layer may be formed of one type of inorganic solid electrolyte, or may be formed of two or more types of inorganic solid electrolytes.

The inorganic solid electrolyte is preferably an oxide-based electrolyte, and from the perspectives of electrical insulation and heat resistance, is preferably aluminum oxide containing sodium. Examples include β-alumina solid electrolytes such as Na-β-alumina (Na₂O-11Al₂O₃) and Na-β″-alumina (β-double-prime alumina (Na₂O-5Al₂O₃)). In both cases, sodium ions can move between the two-dimensional layers that are formed by the alumina blocks, and thus function as an inorganic solid electrolyte. Note that it is more preferable for the inorganic solid electrolyte layer to be made of Na-β″-alumina. The inorganic solid electrolyte layer that is made of Na-β″-alumina also functions as a separator.

The thickness of the inorganic solid electrolyte layer is, for example, 1 mm or less, from the perspective of the energy density and ion conductivity of the battery.

### Anode Layer

The anode layer 18 (counter electrode) is not limited in particular, and an electrode composite material containing an anode active material, a known sodium metal anode, a known sodium alloy anode, or a known sodium ion occluding anode, may be used.

The thickness of the anode layer is, for example, 1 mm or less, from the perspective of the energy density and ion conductivity of the battery.

When a set of a cathode layer, a solid electrolyte layer, and an anode layer, is defined as being a power generation unit, the all-solid-state sodium-ion battery may have just one power generation unit, or may have two or more power generation units. When the solid-state battery has two or more power generating units, the power generating units may be connected in series or may be connected in parallel.

The solid-state battery may be configured by sealing lamination end faces (side faces) of a laminated structure of the cathode layer/solid electrolyte layer/anode layer with a resin. The form of the all-solid-state sodium-ion battery is not limited in particular, and may be, for example, a coin type, a cylindrical type, a square type, a sheet type, a button type, a flat type, or a laminate type.

The present disclosure will be described in more detail below with reference to examples, but the disclosure of the present disclosure is not limited to these examples alone.

### Production of Polymer SE: Comparative Example 2

PEO (Mw≈4,000,000) and NaFSA were mixed in acetonitrile to obtain a molar ratio of EO:Na=15:1. This mixture was cast onto a substrate that is made of fluororesin and dried in a vacuum at 60° C. to produce a polymer SE (thickness: 200 μm).

### Production of Polymer SE: Example 1

Polymer SE (thickness: 200 μm) was produced by the same procedures as in Comparative Example 2, except that PEO and NaFSA were mixed such that the molar ratio of EO:Na was 20:1.

### Production of Polymer SE: Example 2

Polymer SE (thickness: 200 μm) was produced by the same procedures as in Comparative Example 2, except that PEO and NaFSA were mixed such that the molar ratio of EO:Na was 30:1.

### Production of Polymer SE: Example 3

Polymer SE (thickness: 200 μm) was produced by the same procedures as in Comparative Example 2, except that PEO and NaFSA were mixed such that the molar ratio of EO:Na was 50:1.

### Production of Polymer SE: Example 4

Polymer SE (thickness: 200 μm) was produced by the same procedures as in Example 2, except that triphenylboroxin (TPB) was additionally mixed in such that the molar ratio of NaFSA to TPB was 1:0.5.

### Production of Cathode Composite Material

A cathode active material (Na₃V₂(PO₄)₃), acetylene black, and PVdF were mixed in a weight ratio of 75:20:5, and dispersed in N-methyl-2-pyrrolidone (NMP) to prepare a slurry. An aluminum current collector (thickness: 15 μm) was coated with this slurry, to produce a cathode (thickness: 50 μm).

### Production of Cell: Comparative Example 1

First, a foil of sodium metal was punched out to obtain a counter electrode (thickness: 1000 μm).

A cathode, Na-β″-Al₂O₃ (manufactured by NGK Insulators, Ltd., thickness: 1000 μm), and the counter electrode were laminated in this order to produce a coin-shaped evaluation cell.

### Production of Cell: Comparative Example 2, Examples 1 to 4

An evaluation cell was produced in the same manner as in Comparative Example 1, except that polymer SE was disposed between the cathode and Na-β″-Al₂O₃ (manufactured by NGK Insulators, Ltd.).

### Evaluation of Rate Characteristics

The evaluation cell (battery) that was produced was subjected to a constant-current discharge test at 70° C. in a potential range of 3.7 to 2.7 V, at an optional current value. The theoretical capacity of the cathode active material was set to 118 mA/g, and the discharge capacities of 1C (118 mA/g) and 4C (472 mA/g) in particular were compared.

Table 1 shows a comparison of the cell configurations and rate characteristics evaluations. Determination was made that the discharge capacity was high, and the rate characteristics were improved, for discharge capacity of 75 mAh/g or more at 1C rate, or discharge capacity of 10 mAh/g or more at 4C rate.

TABLE 1

| | | Discharge | Discharge |
|---|---|---|---|
| | | Capacity | Capacity |
| | Polymer SE | @1 C | @4 C |
| | Configuration | (mAh/g) | (mAh/g) |
| Comparative | N/A | — | — |
| Example 1 | | | |
| Comparative | NaFSA/PEO | 73 | 0 |
| Example 2 | (Na/EO molar | | |
| | ratio) = 1/15 | | |
| Example 1 | NaFSA/PEO | 80 | 0 |
| | (Na/EO molar | | |
| | ratio) = 1/20 | | |
| Example 2 | NaFSA/PEO | 90 | 2 |
| | (Na/EO molar | | |
| | ratio) = 1/30 | | |
| Example 3 | NaFSA/PEO | 88 | 0 |
| | (Na/EO molar | | |
| | ratio) = 1/50 | | |
| Example 4 | NaFSA/PEO | 65 | 23 |
| | (Na/EO molar | | |
| | ratio) = 1/30, TPB | | |

The cell of Comparative Example 1 in which no polymer SE was disposed had too high a resistance to be charged and discharged, and therefore rate characteristics could not be compared.

It was found that disposing the polymer SE enabled charging and discharging, and that at 1C rate, a high discharge capacity was obtained when the molar ratio of EO:Na of PEO and NaFSA was between 20:1 and 50:1 (Examples 1 to 3).

Also, Example 4 had a lower discharge capacity at 1C rate than in Example 2, which had the same molar ratio of PEO and NaFSA in the polymer SE, but it was found that the discharge capacity at 4C rate was dramatically increased by adding TPB to the polymer SE.

It is presumed that the increase in discharge capacity was due to movement of anions in the polymer SE being suppressed by reducing the Na salt concentration in the polymer SE, or by adding an anion acceptor, thereby facilitating exchange of Na with the cathode active material.

What is claimed is:

1. An organic solid electrolyte, comprising:
sodium bis(fluorosulfonyl)amide (NaFSA); and polyethylene oxide (PEO), wherein, when a constituent unit of PEO is EO, a molar ratio of Na:EO between NaFSA and PEO is within a range of 1:20 to 1:50.

2. The organic solid electrolyte according to claim 1, further comprising a boron-containing additive.

3. The organic solid electrolyte according to claim 2, wherein the boron-containing additive is one type, or two or more types of additives, selected from a group consisting of triphenylboroxine, triphenylborane, and fluorobis(2,4,6-trimethylphenyl)borane.

4. The organic solid electrolyte according to claim 2, wherein the boron-containing additive is triphenylboroxine.

5. An all-solid-state sodium-ion battery comprising:
a cathode layer;
an organic solid electrolyte layer;
an inorganic solid electrolyte layer; and
an anode layer, in order of the cathode layer, the organic solid electrolyte layer, the inorganic solid electrolyte layer, and the anode layer in a thickness direction, wherein the organic solid electrolyte layer is made of the organic solid electrolyte according to claim 1.

6. The all-solid-state sodium-ion battery according to claim 5, wherein the inorganic solid electrolyte layer contains Na-β″-alumina.
